(19) United States
(12) Patent Application Publication
(10) Pub. No.: US 2018/0272666 A1
(43) Pub. Date: Sep. 27, 2018

(54) MOLDABLE CONTAINER LINER HAVING BARRIER PROPERTIES

(71) Applicant: CONVERTER MANUFACTURING, LLC, Orwigsburg, PA (US)

(72) Inventor: Millard F. WALLACE, Orwigsburg, PA (US)

(73) Assignee: CONVERTER MANUFACTURING, LLC, Orwigsburg, PA (US)

(21) Appl. No.: 15/763,100

(22) PCT Filed: Sep. 26, 2016
(86) PCT No.: PCT/US16/53696

§ 371 Date: Mar. 24, 2018

Related U.S. Application Data
(60) Provisional application No. 62/222,810, filed on Sep. 24, 2015.

(51) Int. Cl. B32B 27/08; B32B 27/30; B32B 27/32; B32B 27/34; B65D 25/14; B65D 65/40

(52) U.S. Cl. CPC B32B 27/08; B32B 27/306; B32B 27/32; B32B 27/34; B65D 25/14; B65D 65/40; B65D 2565/385; B32B 2250/24; B32B 2307/7242; B32B 2439/40; B32B 2323/10; B65D 2565/387; B32B 2250/05

(57) ABSTRACT

The disclosure relates to a liner for containers or packages. The liner includes several polymer layers, exhibits a barrier function (e.g., gas or moisture barrier function), and is peelably attachable to one or more container/package surfaces. When the liner lines a package or container the package or container exhibits the liner's barrier function, and the liner can be peeled from the package or container to facilitate recycling or disposal. The liner is thermoformable, and can thus be either shaped to conform to the shape of a pre-formed container or shaped simultaneously with formation of the container from a precursor material to which the liner is peelably bound, either prior to or during container formation.

### BACKGROUND OF THE DISCLOSURE

The invention relates generally to the field of packaging, and more specifically to packages which inhibit passage therethrough of moisture, gases, or other compounds.

Packaging of products is nearly ubiquitous. Packages contain discrete units of products, and can identify and protect packaged products from harm during storage, shipping, and sale. The ubiquity of packaging results in enormous quantities of spent packaging, much of which is discarded after being separated from packaged products.

Only a relatively small proportion of packaging materials are recyclable. Practically recyclable packaging materials are generally formed of a single type of material (e.g., paper pulp, metal foil, or a single type of plastic). Packaging materials which include numerous materials must be separated into their component materials in order to facilitate recycling of those materials. As the difficulty of separating a package into discrete materials increases, the likelihood that any portion of the package will be recycled decreases.

Many packages include multiple materials because those packages must serve numerous functions. In addition to containing the product and bearing information sufficient to identify the contents, containers for some products must i) have specific shapes to adequately contain and protect the product during shipping and/or storage, ii) exhibit the ability to exclude undesirable substances (e.g., moisture, dirt, or reactive gases such as oxygen) from the packaged product, iii) retain volatile, diffusable, or flowable components (e.g., liquids, flavors, or aromas) within the packaged product, or iv) combinations of these. It is because packages must serve such diverse functions that many packages include multiple materials that cannot be recycled in a single stream.

The enormous bulk of packaging materials that are discarded (e.g., in landfills or by incineration) could be reduced if there were packages in which components that are not practically recyclable could be contained in a relatively small portion of the package, especially if that non-recyclable portion could be easily separated from the recyclable component(s) of the packaging. The subject matter described herein provides such packages.

### BRIEF SUMMARY OF THE DISCLOSURE

The invention relates to a thermoformable sheet for lining a container composed of a substrate. The thermoformable sheet is a bonded stack of sheets that includes a substrate binding layer, a sealing layer, and, interposed between the substrate binding layer and the sealing layer in any order, a moisture barrier layer and a gas barrier layer. The substrate binding layer includes at least a first polyethylene, and should be selected so that the substrate binding layer binds with the substrate when the thermoformable sheet is urged against the substrate in a heat-softened state (i.e., the substrate binding layer facing the substrate). The thermoformable sheet should thereafter be peelable from the substrate at 20 degrees Celsius. The sealing layer includes a second polyethylene which can, but need not, be identical to the first. At least one moisture barrier layer includes a polyolefin, such as a layer made completely of the polyolefin (e.g., polypropylene). At least one gas barrier layer should include a polymer (e.g., an ethylene vinyl alcohol layer) that resists permeation by at least one gas (e.g., oxygen) and that polymer can be adjacent a thermoformable nylon layer (or sandwiched between two such layers) to provide physical support to the polymer during shaping operations. All of the layers of the thermoformable sheet are preferably bonded to their adjacent layers to yield the finished thermoformable sheet.

Polyethylenes that are useful in the substrate barrier layer include, for example ethylene vinyl acetates (EVAs), low density polyethylenes (LDPEs), linear low density polyethylenes (LLDPEs), and blends of these. By way of example, the substrate binding layer can be a blend of an EVA and a LLDPE. Alternatively, the substrate binding layer can be a blend of an EVA, a LDPE, and a LLDPE.

At least one polyethylene used in the sealing layer is preferably a low-set LLDPE, such as a metallocene LLDPE, a cycloolefin/LLDPE copolymer, an EVA, or a combination of these.

The outer surface of the sealing layer of the thermoformable sheet can be corona treated.

The thermoformable sheet can have an overall thickness from 3 to 10 mils, for example, and can be used to line a substrate. By way of example, described herein is an assembly that includes a container made from a substrate and defining a concave surface. The thermoformable sheet can be peelably bound to the concave surface of the container. Furthermore, the assembly can further include a lidding material that is bound to the sealing layer of the thermoformable sheet about the periphery of the concave surface, thereby defining a closed compartment defined by the thermoformable sheet and the lidding. The thermoformable sheet described herein can be used to line a container, such as one that is made of a recyclable material. By peeling the thermoformable sheet (which contains a variety of materials, and can therefore be inappropriate for recycling) from the container, the bulk of the container can be recycled. Such thermoformable sheet-lined containers can be made by binding the thermoformable sheet to the substrate after it has been formed into a desired shape, during such shaping operations (e.g., by simultaneously shaping a substrate sheet and a thermoformable sheet applied against it) or before shaping operations (e.g., by binding flat substrate and thermoformable sheets and thereafter shaping the unitary bound sheet).

### DETAILED DESCRIPTION

The disclosure relates to a thermoformable liner material designed to form a portion of a product package (e.g. an open-top container), such that the liner can be removed from the container, for example, to facilitate recycling of the container. The liner can be selected to provide favorable barrier properties, such as an extremely low oxygen transmission rate (OTR) and/or moisture vapor transmission rate (MVTR). Other favorable properties of liners are that materials used to make the liners (or at least the portions which contact a product) can be selected to minimize release of liner components into the product (e.g., to miminize diffusion from a plastic layer of components such as bisphenol A, a common plasticizer; this phenomenon is commonly known as “extraction” or “leaching” of liner components into a product) and/or to minimize uptake into liner components of components originating in the product (e.g., to minimize absorption by the liner of molecules which confer flavor or aroma to a packaged foodstuff; this phenomenon is commonly known as “scalping”).

The liner material can be peeled off from substrates to which it is applied in order to enhance recyclability of that substrate after the container has served its intended purpose. Alternatively, the liner can be left in place on the container after its use, and the composite structure can be discarded with ordinary trash. Because the liner is relatively thin (e.g., about 4-8 mils, equivalent to 0.004-0.008 inches in thickness), relatively little plastic resin is required to make it, and its discard results in relatively little trash. Being composed of a mixture of plastic resins, the liner itself will usually be practically non-recyclable. However, the ability to peel the liner from a bulkier container (e.g., a plastic tray, paperboard, or pressed paper fiber container) means that the bulkier container can be recycled, while only the relatively small liner need be discarded (or incinerated) as trash. In this way, the liner (and packages lined with it) described herein can significantly decrease the quantity and volume of refuse which must be landfilled, incinerated, or otherwise disposed of.

Notable characteristics of the liner is that it is thermoformable, and that all of the plastic resins selected for inclusion in the liner are selected to exhibit relatively little shrink upon heating, forming, and cooling. Thus, the liner can be mated with other components (e.g., a plastic or paper fiber sheet) prior to formation of a finished container, during such formation, or even after a finished (but non-lined) container has been made. By way of example, the liner can be laminated against a flat sheet of polyethylene terephthalate (PET) prior to thermoforming the liner-PET into a shaped container, such as a tray. By way of an alternative example, a flat sheet of the liner can be softened by heat and formed and sealed against the interior of a pre-formed tray-shaped container (e.g., a plastic container or one formed from a wood pulp slurry); if desired, a lidding can be applied across the periphery of the concave side of the tray and sealed against the sealing layer of the liner, thereby creating a sealed compartment suitable for use in modified atmosphere packaging (MAP), for example. By way of yet another alternative example, both the liner and another material (e.g., a paper pulp) can be pre-formed into nestable shapes (e.g., a common 12-egg carton), the shaped liner can be nested within the shaped material, and application of heat can seal the liner to the interior of the material, yielding a peelably lined egg carton. In any of these examples, the liner can confer important barrier properties to the container and can be peeled from the other, recyclable container materials when the container is no longer needed.

Another notable characteristic of the liner is that the liner exhibits significant barrier properties. The liner is thus suitable for lining packaging intended for use with materials (e.g., foodstuffs and electronics) which must be shielded from environmental factors (e.g., oxygen or moisture) which are capable of adversely affecting the contents of the packaging. The barrier properties of the liner (or one or more layers of the liner, such as the layer nearest a product packaged adjacent the liner) can also prevent migration of components between the product and the liner (or the substrate to which the liner is attached). The barrier properties conferred to the container result from the selection of liner components which exhibit those properties. By way of example, ethylene vinyl alcohol (EVOH) exhibits significant resistance to passage of oxygen and other gases, and polyolefins (especially polypropylene and high density polyethylene (HDPE)) exhibit significant resistance to passage of moisture. Thus, including an EVOH layer within the liner will cause the liner (and any container it lines) to resist transmission of oxygen therethrough, and including a polypropylene or HDPE layer within the liner will cause the liner (and any container it lines) to resist transmission of moisture therethrough. Similarly, selection of sealing layer components (e.g., mLLDPE and COC-LLDPE materials described herein) that are highly resistant to infiltration by flavor and aroma components of packaged foodstuffs will cause the liner to resist “scalping” (i.e., absorption by the packaging) or loss to the environment of such flavor or aroma components.

The liner described herein is suitable for lining containers intended to contain a wide variety of products. In an important embodiment, the containers are intended to contain dry goods such as delicate electronic components or particulate foodstuffs (e.g., ground coffee, coffee beans, tea, spices, cereals, or grains) which must be shielded from environmental moisture and/or oxygen (i.e., the liner is intended to exclude from the interior of the container materials which normally occur on the exterior of the container). In another important embodiment, the containers are intended to retain within the container components of the packaged product, such as moisture, flavors, and odors of packaged foodstuffs (e.g., packaged meats, cheeses, coffee, tea, or spices). Containers including the liner described herein can, of course, be intended both to exclude undesirable environmental components and to retain desirable product components.

The liners described herein are thermoformable, meaning that they can be shaped upon application to the liner of heat. Thermoformability confers to the liners the important characteristic that they can be adapted to conform to the shape of substantially any package or container. The liner can thus be substantially indistinguishable from the remainder of the package, both to a packager and to a consumer of the packaged articles, eliminating the inconvenience of forming and opening a “package within a package.” Despite being conformable to the shape of (e.g., the interior of) a package, the liner can nonetheless be peeled or stripped from the remainder of the package (preferably in one piece) and discarded, facilitating recycling of the remainder of the package if desired.

In addition to being conformable to a package, at least some embodiments of the liners described herein are sealable. That is, in addition to being attachable to a packaging material (yielding a package having an open portion), the liner can be attached to a sealing material that seals the open portion of the package and yields a compartment bounded by the liner and the sealing material. The sealing material can be another piece (or a flap of the same piece) of the liner that lines the package, in which embodiment the compartment is bounded solely by the liner.

Further details regarding the composition of the liner, ways of making it, and ways of using it are described in the following sections.

The Liner

The liner is composed of several polymer layers, bonded together into a thermoformable sheet. The liner includes a substrate binding layer on one face and a sealing layer on the opposite face of the liner. Between these two sheets are at least one polyolefin (preferably polypropylene or HDPE) moisture barrier layer and at least one ‘sandwich’ that includes a gas barrier layer interposed between a pair of thermoformable nylon layers. In one embodiment, those layers include the following six (optionally, and preferably, seven) layers, listed in order from the exterior (packaging) face of the liner toward the interior (product) face of the liner:

1. A substrate binding layer.

2. An outer moisture barrier layer.

3. An outer nylon layer.

4. A gas barrier layer.

5. An inner nylon layer.

6. (Optional, but preferable) An inner moisture barrier layer.

7. A sealing layer.

The inner and outer moisture barrier layers in the foregoing embodiment inhibit migration of moisture from corresponding faces of the liner to the gas barrier layer, and thereby facilitate use in the gas barrier layer of materials (e.g., EVOH) which are known to exhibit greater gas barrier properties in an anhydrous state.

In another embodiment, the liner include the following nine layers, listed in order from the exterior (packaging) face of the liner toward the interior (product) face of the liner:

1. A substrate binding layer.

2. A first outer nylon layer.

3. A first gas barrier layer.

4. A first inner nylon layer.

5. A moisture barrier layer.

6. A second outer nylon layer.

7. A second gas barrier layer.

8. A second inner nylon layer.

9. A sealing layer.

It is important that the gas barrier layer be sandwiched between a pair of nylon layers (less preferably, bound to just one adjacent nylon layer), in order to provide physical support to the gas barrier layer during thermoforming or other shaping while the liner is in a heat-softened form. If the sandwich containing the gas barrier layer is susceptible to moisture transmission therethrough and the gas-transmission-inhibiting function of the gas barrier layer is susceptible to degradation in the presence of moisture, it can also be important that the gas barrier layer lie between a pair of moisture barrier layers, as well.

In short, it is important that the liner include both a moisture barrier layer (such as a polypropylene layer or an HDPE layer) and a functional gas-transmission-inhibiting layer, such as the sandwich including the gas barrier layer sandwiched between thermoformable nylon layers.

Substrate Binding Layer

The liner includes a substrate binding layer that has the important characteristics that i) it binds to the substrate and ii) it is peelable from the substrate at a normal operating temperature (e.g., at room temperature or 20 degrees Celsius, or at the temperature of hot coffee grounds in a container that has the liner described herein peelably bound thereto). In one embodiment, the substrate binding layer includes at least one polyetheylene (PE), and preferably is a blend of one or more components selected from among EVAs and polyolefins. (Note, however, that if the substrate were a PE or a polypropylene (PP), for example, the substrate binding layer would preferably not be a polyolefin, because the two polyolefin layers may become non-peelably bound to one another if subjected, for example, to sufficient heating to fuse the substrate and the substrate binding layer. In such a situation, the substrate binding layer might include a PET or a PVC, rather than a PE, to bind with the PE or PP substrate.) Preferably, the substrate binding layer is a blend of at least one EVA with with one or more LDPEs and/or with one or more LLDPEs. It can, for example, be a blend of EVAs, LDPEs, and LLDPEs.

The function of the substrate binding layer is to peelably bond the liner to a surface of a substrate, such as a plastic or wood/paper fiber surface. Owing to the selection of the polymer blend selected for the substrate binding layer, it will peelably bind to most surfaces (other than surfaces composed of the same, or miscible polymers, to which surfaces it will instead weld or merge), including the surfaces of common packaging materials such as paper, cardboard, thickened wood fiber slurry (e.g., common egg cartons), polyvinylchloride (PVC), and PET. The selection of the polymer blend permits this binding to occur at relatively low processing temperatures—well within the range of temperatures which common packaging materials can endure without significant degradation. What is important in selecting polymer resins for the substrate binding layer is that, when softened, the substrate binding must adhere to the substrate, but must (upon cooling) remain peelable from the substrate. If the polymer blend of the substrate binding layer were miscible with the polymer composition of the substrate, then the liner would not be peelable from the substrate upon cooling.

The precise blend of polymers (e.g., EVA and LDPE/LLDPE) used for the substrate binding layer is not critical, and design of such low-melting or low-softening materials from these components is well known in the art. Increasing the content of EVA will tend to increase the adherence of the melted or softened material to the substrate surface and lower the melting/softening temperature of the substrate binding layer, but will also tend to increase the force required to peel the substrate binding layer from the substrate. Increasing the content of LDPE and/or LLDPE will tend to stiffen and strengthen the substrate binding layer. Selection of an appropriate blend of EVA and LDPE/LLDPE, for example, is within the level of skill of an ordinary artisan, in view of the guidance and goals set forth herein. Suitable EVA content of the substrate binding layer is, for example from 2% to 95% by weight, depending on the nature of the substrate and the desired tenacity of binding between the substrate and the substrate binding layer. Examples of suitable EVA contents are about 12 wt % when the substrate is a coarse fiber slurry product (e.g., a common paper egg carton), about 20 wt % when the substrate is a smooth, low porosity paper or cardboard, and about 8 wt % when the substrate is smooth plastic surface such as PVC or PET.

Moisture Barrier Layers

A moisture barrier layer inhibits or prevents migration of water through the layer. Polyolefins are highly moisture-resistant, and polypropylenes are particularly effective moisture barriers. Conventional high density polyethylenes (HDPEs) are also effective moisture barriers. In addition, polypropylene (and other thermoformable polyolefins) tend to be inexpensive, simple to process in the methods described herein, and readily available. The moisture barrier layer(s) of the liners described herein are therefore primarily or entirely composed of polypropylenes, preferably an impact grade polypropylene resin, or of HDPE. Although other polymers that resist the passage of water can be used, the combination of favorable characteristics of polypropylene make it a preferred material. Blends of HDPE and polypropylene (e.g., 80:20 or 20:80 by weight) are also suitable.

Nylon Layers

The function of the nylon layers is to provide physical support to (i.e., prevent tearing or development of holes in) one or more gas barrier layers. Gas barrier layer materials such as EVOH tend to be brittle and to crack or develop pin-holes during thermoforming operations unless supported by other materials. It is this support which one or more nylon layers provide. Preferably, each gas barrier layer is sandwiched between (preferably in direct contact with each of) a pair of nylon layers. However, as few as a single nylon layer adjacent a gas barrier layer will suffice to support the integrity of the gas barrier layer during liner softening and shaping.

The nylon selected for the nylon layers should be a thermoformable nylon, such as the product commonly referred to in the field as “PA-6.” PA-6 has the lowest glass transition of the 3 nylons so it is easier to process and less expensive than other common nylons.

Gas Barrier Layers

The function of a gas barrier layer is to prevent transmission of gases (e.g., oxygen, carbon dioxide, water vapor) across the layer. A wide variety of gas barrier polymers is known, and substantially any gas barrier polymer capable of withstanding the stresses and conditions of fitting the liner described herein snugly against surfaces of a container can be used. A preferred gas barrier layer is EVOH (which substantially inhibits transmission of oxygen), which is a well-known gas barrier polymer available in a variety of forms and grades. For the purposes described herein, EVOH polymers formulated to be suitable for operations such as thermoforming (especially for thermoforming involving deep draw) are especially preferred. An example of such a suitable EVOH polymer is the product known by the trade name EVAL, available from Kuraray Polymers (Antwerp, Belgium). Other polymers having gas barrier properties include polyvinyl chlorides, polyvinylidene chlorides, and polyethylene terephthalate, for example.

The gas barrier layer should be used in a thickness equivalent to ordinary uses of such polymers (i.e., per manufacturer instructions). An important characteristic of the liners described herein is that each gas barrier layer is sandwiched between (preferably with no intervening polymer layers) two nylon layers. The nylon layers improve the stability of the gas barrier layer, preventing cracks and holes which could decrease the barrier functionality of the gas barrier layer.

The Sealing Layer

The liners described herein include at least one sealing layer (and preferably only one sealing layer), preferably situated on the face of the liner opposite the substrate binding layer. The function of the sealing layer is to permit a seal to be formed between the sealing layer and either itself (e.g., in a container that is folded upon itself) or a lidding material (e.g., a transparent polymer film which can optionally exhibit barrier properties similar or identical to those of the liner). By way of example, if the surface of a concavity within a container (e.g., the interior of a bowl) is coated with the liner (i.e., the liner is bound by way of its substrate binding layer along the entirety of the surface of the concavity up to the edge of the orifice of the concavity, but the orifice is open), then binding a lidding to the sealing layer about the periphery of the concavity will create a completely sealed compartment bounded by the liner (within the concavity) and the lidding (covering the orifice of the concavity). Such arrangements are often used to contain liquids or in modified atmosphere packaging (MAP) applications.

The lidding or other material to which the sealing layer binds preferably has a composition (at least at the surface which contacts the sealing layer) similar or identical to the composition of the sealing layer, to facilitate formation of a strong bond between the material and the liner. In one embodiment, the material is a piece of the same material used as the liner (e.g., a flap of the liner that is not attached to the substrate and can be folded to cover an orifice defined by the substrate and about the periphery of which the liner is attached to the substrate; alternatively, a discrete piece of the liner material). In another embodiment, the substrate is folded back on itself, so that the sealing layer (i.e., the face of the liner opposite the substrate binding face) on different parts of the liner are opposed against, and sealed to, each other. In yet another embodiment, the material is a lidding composed of a commercially available lidstock material, selected such that an outer layer of the lidstock has a composition that is, when melted, miscible with the molten sealing layer, so that a strong seal can be made by urging the molten sealing layer and outer lidstock layer against one another.

Because the sealing layer is situated opposite the substrate binding face of the liner, it is foreseeable that the sealing layer will sometimes contact the product contained within the container formed by the substrate to which the liner is bound. In such situations, it is important to select the sealing layer that is non-reactive with the product (i.e., the sealing layer material does not participate in chemical reactions with the product nor leach into the product any sealing layer component that is inappropriate in the product, nor leach from the product any product component desired to be maintained in the product).

It is also important that the composition of the sealing layer be selected to facilitate sealing of the seal to the liner. Materials which form a good seal quickly under conditions of low heating are preferred, for example. Low-set polyethylenes (e.g., mLLDPEs, COC-LLDPEs, and EVAs) and their blends soften or melt sufficiently to merge with miscible polymers or blends at reasonable sealing temperatures (i.e., temperatures at which the liner will not completely melt or degrade, such as temperatures not greater than about 300 degrees Fahrenheit) are suitable materials for the sealing layer.

There are at least two materials which are believed to exhibit particularly favorable combinations of characteristics as sealing materials: LLDPE/cycloolefin copolymers (COC-LLDPEs) and LLDPEs made using metallocene catalysts (mLLDPEs).

Very thin layers of mLLDPEs can be used as sealing layers and yield a good seal quickly at low sealing temperatures. Corona surface treatment of mLLDPEs can reduce the propensity of mLLDPEs (like all other polyethylenes) to absorb compounds (e.g., flavors or aromas) from a product that contacts the mLLDPE. mLLDPEs are well known in the art, as are their properties and methods of manufacture.

COC-LLDPEs are similarly known in the art. COC-LLDPEs are known, for example, to exhibit low leaching of compounds from or to products they contact. They also are known to exhibit excellent tensile strength and sealability at moderate temperatures and, like mLLDPEs, exhibit excellent barrier characteristics and thermoforming properties. Because the density of COC-LLDPEs is relatively low, they will float on water, facilitating separation of liners containing LLDPEs from denser-than-water components in recycling processes.

mLLDPEs and COC-LLDPEs are not the only materials for use as or in the sealing layer of the liners described herein. Substantially any polymer that exhibits sufficient post-sealing tensile strength to resist tearing of the seal can be used. Preferably, the material softens or melts sufficiently to seal at as low a temperature as possible (preferably at a temperature in the range from 150-300 degrees Fahrenheit). Selection of a material that tends not to leach components into, nor extract components from, a product that contacts the sealing layer can be important, depending on the identity and nature of the product.

The sealing layer can also include one or more EVAs, in addition to one or both of mLLDPEs and COC-LLDPEs. As is known in the art, inclusion of EVAs (e.g., 2%-95% by weight) in such a polymer blend can positively affect the melting point, tackiness, and seal strength of the sealing layer. The composition of the sealing layer should be selected to be miscible with at least the outermost layer of any lidding material with which the sealing layer is intended to bond.

Making the Liner

The liner is essentially a multi-layer polymer sheet. Substantially any known method for making multi-layer polymer sheet can be used to produce the liner described herein. Suitable techniques include co-extrusion of the various plastic resins (and any required tie layers), followed by casting or blowing. Other suitable techniques include lamination of various homopolymer sheets or multi-polymer sheets (and any required tie layers), followed by heating to bond the adjacent sheets to one another. The method by which the liner is made is not critical, so long as a polymer sheet having the various layers described herein is formed. A skilled artisan is able to select among known polymer processing methods a variety of appropriate production methods that will yield the liners described herein.

Preferably, the liner is made in the form of the multi-layer polymer sheet described herein and distributed in that form to product packagers or to package manufacturers. In this form, the liners can be supplied as discrete sheets (e.g., sized and shaped to fit a particular package), or as larger sheets or rolled sheets to be cut and fit by a packer or package manufacturer.

In an alternative embodiment, the liner is provided in a not-yet-assembled form, the component parts of the liner to be assembled by an end user. By way of example, the substrate binding layer and sealing layer can be supplied as separate sheets or separate rolled materials. Similarly, the moisture barrier layer(s) can be supplied separately. The gas barrier layer is preferably supplied in a form in which it is already sandwiched between nylon layers (or attached or adjacent to at least one nylon layer). By supplying these materials in separated forms, the number and arrangement of moisture barrier and gas-barrier layers in the liner can be selected by the end user. To do so, the end user forms a liner by interposing one or more moisture barrier layers and one or more gas-barrier layers between the substrate binding layer and the sealing layer and forming the liner (e.g., by simultaneously thermoforming the various layers, optionally together with the substrate material to which the liner is to be bound). When the discrete layers are to be separately supplied to an end user, they should be supplied in a state that facilitates assembly of the liner by the end user (e.g., with any tie layers necessary to bind adjacent layers already affixed to one or more of the layers). By way of example, the discrete layers can be supplied as layers intended to be laminated by the end user, for example before or while conforming the materials to the substrate to which the liner is to be attached.

Using the Liners

The liners are intended to serve as a removable part of a container, separable from other parts of the container. In particular, the liner are intended to confer particular barrier characteristics to a container, using only a small amount of (generally non-recyclable) packaging materials, while other characteristics and functions of the container are conferred by recyclable materials that can be readily separated from the liner. The liners can therefore greatly reduce the quantity of non-recyclable solid waste attributable to product packaging, while retaining the characteristics and functions of traditional packaging.

The liners perform this role by binding to one or more surfaces of a packaging substrate and, optionally, forming a closed compartment about a product by sealing the liner about the product or, alternatively, by sealing to one or more seals (e.g., a metal foil, or a plastic-coated metal lid) that form part of the periphery of the closed compartment.

The method by which the liner is bound to the packaging substrate is not critical. In one embodiment, a package (or a portion thereof) is pre-formed, and the liner is bound to the preformed package (or portion). By way of example, a common 12-egg carton can be formed by pressing a wood/paper-fiber slurry between halves of a mold and drying the shaped fiber mass to yield a pre-formed egg carton. A liner sheet, as described herein, can be heated so that at least the substrate binding layer thereof is softened sufficiently that when that layer is urged against the interior of the egg carton (e.g., by application of a vacuum through the carton material, drawing into the interior of the carton a softened liner sheet applied above the interior of the carton with its substrate binding layer facing the carton), the substrate binding layer conforms to the shape of and binds against the interior of the egg carton, resulting in a carton lined with the liner sheet. Any portion of the liner sheet that overhangs an edge of the carton can be trimmed away, and a portion of such overhang can be retained for use as a tab to initiate peeling of the liner from the carton after use. The liner can be discarded after peeling, and the fiber carton remains suitable for recycling, even if one or more eggs that were contained therein broke (since the spilled egg contents would be prevented by the liner from contacting the fiber portion of the carton).

In another embodiment, the liner is attached to a precursor (e.g., a flat piece of paperboard or a flat plastic sheet) from which the package is subsequently formed. By way of example, a liner sheet can be adhered to a flat sheet of PVC, and the PVC sheet, with the liner attached, can subsequently be thermoformed into the shape of a tray for containing a cut of meat, with any excess PVC or liner material beyond the rim of the tray trimmed away. After placing a cut of meat within the concavity of the tray (i.e., the liner being attached to the concave face of the PVC sheet; that is, lining the concavity), a clear plastic lidstock material can be sealed to the liner about the periphery of the concavity, forming a closed compartment that contains the cut of meat and any juices which emanate from it. The liner can be peeled from the tray (before or after breaching the closed compartment), yielding a clean PVC tray suitable for recycling and a soiled liner (and lidstock) suitable for discarding. Because the liner and lidstock can constitute a very small proportion of the material used to form the container, the clean PVC that is recyclable can represent a large proportion of that material, meaning that a substantial portion of the tray can be recycled.

It is substantially immaterial how the liner is caused to bind to the substrate surface, other than that at least the substrate binding layer of the liner should be melted or softened sufficiently to facilitate binding of that layer to the substrate. A wide variety of methods can be used to urge the melted or softened substrate-binding layer against the substrate, including application of positive or negative air pressure, physical pressing of the liner against the substrate (e.g., with the assistance of a positive mold or plug applied to the face of the liner opposite the substrate), permitting a softened liner sheet to sag against the substrate surface under the influence of gravity, or any other method of closely opposing the softened or melted substrate binding layer of the liner against the substrate surface.

Peeling of the liner from the substrate can be facilitated by attaching a tab at or near an edge of the liner, by leaving a piece of liner (i.e., a tab that is unitary with the liner) that extends beyond the substrate (or by cutting away a portion of the substrate, while leaving uncut the corresponding portion of the liner), by treating a portion of the substrate prior to contacting it with the softened or melted substrate binding layer of the liner in such a way that binding between the treated portion of the substrate and the liner is inhibited, or in other ways apparent to skilled artisans in this field (e.g., by using a portion of a lidding sealed to the sealing layer of the liner as a tab). Because the substrate will often be intended to be recycled, the physical state of the substrate will often be immaterial. Thus, peeling of the liner from the substrate can be facilitated by providing a making a portion of the substrate easily torn or bent, so that separation of the substrate and the liner at the torn or bent portion can yield a graspable portion of the liner, so as to facilitate subsequent peeling of the liner from the substrate.

Definitions

As used herein, each of the following terms has the meaning associated with it in this section.

A polymer sheet is “bound” to a surface (e.g., a packaging material surface or another polymer sheet) if it is sufficiently tenaciously fixed to the surface at the intersection(s) of the polymer and the surface that the polymer sheet does not simply fall away from the surface under its own weight or with minimal separating force. In the specialized situation of polymer sheets that are “bound” to one another in adjacent layers of the liners described herein, it is known in the art that polymer sheets can be bound to one another in a variety of ways, including by simple adhesion (e.g., that which occurs upon casting or blown co-extrusion or lamination), by including an adhesive or a tie layer between the polymer sheets, or by fusion of the sheets.

A polymer sheet is “peelably” bound to a surface, as used herein, if the bound sheet can be peeled away from the surface by a human of ordinary strength. Put another way, the sheet is “peelable” if it is sufficiently flexible and has sufficient tensile strength that it can be peeled away from the surface without the polymer sheet tearing. For the peelable liners described herein (i.e., wherein the liner is intended to be discarded, while the surface to which it is bound is intended to be recycled), it is immaterial if a portion of the surface to which the sheet is bound (e.g., the adjacent layer of a paperboard substrate) remains adhered to the liner when the liner is peeled from the substrate, although it is preferable that such tearing of the substrate does not occur upon liner peeling.

A “tie layer” interposed between two polymers sheets or layers is a material which bonds to each of the two sheets/layers and thereby bonds the two sheets/layers together. The identities of tie layers appropriate for use with the materials described herein will depend on the identity of the materials selected, but is immediately apparent to a skilled worker in this field once those materials are selected. Appropriate tie layers for binding various polymers are well known and described in the art.

“Linear low density polyethylene” (“LLDPE”), is used herein in its art-accepted sense, meaning copolymers of ethylene with one or more comonomers selected from alpha olefins (preferably C-4 to C-10 alpha olefins such as butene-1 or octene) in which the copolymer molecules are in the form of long chains having few side chain branches or cross-links. This structure is in contrast with conventional low density polyethylenes, which are more highly branched than LLDPE. The density of LLDPE is normally in the range of from about 0.916 to about 0.925 grams per cubic centimeter.

“Low density polyethylene” (“LDPE”), is used herein in its art-accepted sense, meaning copolymers of ethylene, optionally with one or more comonomers selected from alpha olefins (preferably C-4 to C-10 alpha olefins such as butene-1 or octene) as minor components. This structure is in contrast with conventional medium density polyethylenes, which are more highly branched than LDPE. The density of LDPE is normally in the range of from about 0.910 to 0.940 grams per cubic centimeter.

“High density polyethylene” (“HDPE”), is used herein in its art-accepted sense, meaning polymers of ethylene, optionally with one or more comonomers selected from alpha olefins (preferably C-4 to C-10 alpha olefins such as butene-1 or octene) as minor components. The density of HDPE is greater than 0.940 grams per cubic centimeter.

“Ethylene vinyl acetate” (“EVA”), as used herein, is a known chemical entity and refers to copolymers of ethylene and vinyl acetate monomers. Normally, the ethylene-derived units of the copolymer are present in major amounts, such as between about 60% and 98% by weight and the vinyl acetate derived units in the copolymer are present in minor amounts, such as between about 2% and 40% by weight.

“Polyolefins,” is used herein in its art-accepted sense, meaning polymerized alkenyl compounds, including polyethylene, polypropylene, resinous copolymers of ethylene and propylene, and polymers of ethylene and/or propylene with minor proportions of olefinically unsaturated monomers such as alpha-olefins having from 2 to 8 carbon atoms (e.g., 1-butene, 1-pentene, 1-hexene, 1-heptene, 1-octene and mixed higher alpha-olefins). Polypropylene is a preferred polyolefin for the moisture barrier layers described herein.

“Nylons,” is used herein in its art-accepted sense, meaning polyamides having amide linkages among the molecular chains. Nylons includes polyamides made from a single polymer such as PA-6 (nylon 6) and polyamide copolymers, such as blends of nylon 6 and nylon 12.

“Metallocene” polymers are produced using single-site metallocene catalysts, which produce polymers with a narrow molecular weight distribution and uniform molecular architecture. That is, metallocene catalysts provide polymers in which the order and orientation of the monomers in the polymer, and the amount and type of branching is essentially the same in each polymer chain. The narrow molecular weight distribution and uniform molecular architecture provides metallocene polymers with properties that are not available with conventional polymers, and allow polymers to be produced having unique properties that are specifically tailored to a particular application. The desired molecular weight distribution and the molecular architecture are obtained by the selection of the appropriate metallocene catalyst and polymerization conditions.

“Ethylene vinyl alcohol” (“EVOH”), as used herein, is a known chemical entity and refers to saponified or hydrolyzed ethylene vinyl acetate polymers, and refers to a vinyl alcohol polymer prepared by, for example, hydrolysis of a vinyl acetate polymer, or by polymerization of polyvinyl alcohol. The degree of hydrolysis should be at least 50% and is more preferably at least 85%. EVOH is normally used in the form of a copolymer of EVOH and a polyolefin comonomer (e.g., polyethylene). The polyolefin component can, for example, be present in the range of about 15 to about 65 mole percent, and an EVOH content of about 38 mole percent is generally satisfactory for the uses described herein.

### EXAMPLE

The subject matter of this disclosure is now described with reference to the following Example. This Example is provided for the purpose of illustration only, and the subject matter is not limited to this Example, but rather encompasses all variations which are evident as a result of the teaching provided herein.

### Example 1

The following table indicates the order, layer composition, layer proportion (of total liner composition by weight), and layer thickness values for a liner made as described herein.

| Layer | Composition |
|---|---|
| A | EVA/LLDPE |
| B | Tie Layer |
| C | Polypropylene |
| D | Tie Layer |
| E | PA-6 |
| F | EVOH/PE |
| G | PA-6 |
| H | Tie Layer |
| I | LLDPE/COC-LLDPE |

The disclosure of every patent, patent application, and publication cited herein is hereby incorporated herein by reference in its entirety.

While this subject matter has been disclosed with reference to specific embodiments, it is apparent that other embodiments and variations can be devised by others skilled in the art without departing from the true spirit and scope of the subject matter described herein. The appended claims include all such embodiments and equivalent variations.

1. A thermoformable sheet for lining a container composed of a substrate, the sheet comprising a bonded stack of sheets including
a substrate binding layer comprising at least a first polyethylene, the first polyethylene being selected such that the substrate binding layer binds with the substrate when urged, in a heat-softened state, against the substrate and is thereafter peelable from the substrate at 20 degrees Celsius,
a sealing layer comprising a second polyethylene, and, interposed between the substrate binding layer and the sealing layer in any order:
at least one moisture barrier layer comprising at least one polyolefin and
at least one gas barrier layer comprising an ethylene vinyl alcohol (EVOH) layer adjacent at least one thermoformable nylon layer,
all layers of the liner being bonded to the adjacent layers to yield the thermoformable sheet.

2. The thermoformable sheet of claim 1, wherein the first polyethylene is selected from the group consisting of ethylene vinyl acetates (EVAs), low density polyethylenes (LDPEs), and linear low density polyethylenes (LLDPEs), and blends of these.

3. The thermoformable sheet of claim 2, wherein the substrate binding layer is a blend of an EVA and a LLDPE.

4. The thermoformable sheet of claim 2, wherein the substrate binding layer is a blend of an EVA, a LDPE, and a LLDPE.

5. The thermoformable sheet of claim 1, wherein the second polyethylene is a low-set LLDPE.

6-10. (canceled)

11. The thermoformable sheet of claim 1, wherein at least one moisture barrier comprises a polypropylene.

12. The thermoformable sheet of claim 1, wherein at least one moisture barrier consists of a polypropylene.

13-14. (canceled)

15. The thermoformable sheet of claim 1, wherein the EVOH layer of at least one gas barrier layer is sandwiched between two adjacent thermoformable nylon layers.

16. The thermoformable sheet of claim 1, comprising a gas barrier layer in which the EVOH layer is sandwiched between two adjacent thermoformable nylon layers, an outer moisture barrier layer interposed between the substrate binding layer and the gas barrier layer and an inner moisture barrier layer interposed between the sealing layer and the gas barrier layer.

17. The thermoformable sheet of claim 1, wherein the moisture barrier layer is sandwiched between an outer gas barrier layer in which the EVOH layer is sandwiched between two adjacent thermoformable nylon layers and an inner gas barrier layer in which the EVOH layer is sandwiched between two adjacent thermoformable nylon layers.

18. The thermoformable sheet of claim 1, wherein the outer surface of the sealing layer is corona treated.

19. The thermoformable sheet of claim 1, wherein the overall thickness of the sheet is from 3 to 10 mils.

20. An assembly comprising a container composed of a substrate and defining a concave surface and having the thermoformable sheet of claim 1 peelably bound to the concave surface.

21. The assembly of claim 20, wherein the thermoformable sheet covers the periphery of the concave surface, the assembly further comprising a lidding bound to the sealing layer of the thermoformable sheet about the periphery of the concave surface, thereby defining a closed compartment defined by the thermoformable sheet and the lidding.

22. A thermoformable sheet for lining a container composed of a substrate, the sheet comprising
a substrate binding layer being a blend of an ethylene vinyl acetate (EVA) and at least one of a low density polyethylene (LDPE) and a linear low density polyethylene (LLDPE), the blend being selected to bind with the substrate when urged, in a heat-softened state, against the substrate and to be peelable from the substrate at 20 degrees Celsius, the substrate binding layer being bound to the outer face of
an outer moisture barrier layer having an outer face and an inner face, comprising at least one polyolefin; the inner face of the outer moisture barrier layer being bound to the outer face of
an outer nylon layer having an outer face and an inner face, comprising a thermoformable nylon, the inner face of the outer nylon layer being bound to the outer face of
a gas barrier layer having an outer face and an inner face, comprising an ethylene vinyl alcohol (EVOH), the inner face of the gas barrier layer being bound to the outer face of
an inner nylon layer having an outer and inner face, comprising a thermoformable nylon, the inner face of the inner nylon layer being bound to the outer face of either
i) a sealing layer having an outer face and an inner face, comprising a low-set LLDPE or
ii) an optional inner moisture barrier layer having an outer face and an inner face, comprising at least one polyolefin; the inner face of the inner moisture barrier layer being bound to the outer face of the sealing layer.

23. The thermoformable sheet of claim 22, wherein the inner face of the inner nylon layer is bound to the outer face of the inner moisture barrier layer and the inner face of the inner moisture barrier layer is bound to the outer face of the sealing layer.

24. A container comprising a recyclable portion having the substrate binding layer of the thermoformable sheet of claim 22 peelably bound to a surface thereof.

25. The container of claim 24, the container defining a concave interior surface to which the sheet is bound.

26. The container of claim 25, wherein the concave interior surface merges with the exterior of the container at an edge circumscribing the concave interior surface and wherein sheet is bound to the entirety of the concave interior surface, including at the edge.

27. The container of claim 26, wherein the inner face of the sealing layer of the sheet is bound to a seal.

28. The container of claim 27, wherein the inner face of the sealing layer of the sheet is bound to the seal about the entire edge.

29. The container of claim 28, wherein the seal is a portion of the same sheet.

30. (canceled)

31. The container of claim 27, wherein the seal is a piece of material having a surface with the same composition as the sealing layer of the sheet.

32-35. (canceled)
